(19) United States
(12) Patent Application Publication
(10) Pub. No.: US 2009/0172053 A1
(43) Pub. Date: Jul. 2, 2009

(54) ARITHMETIC APPARATUS FOR MULTI-FUNCTION UNIT AND METHOD

(75) Inventors: Byeong-Gyu Nam, Daejeon (KR); Hoi-Jun Yoo, Daejeon (KR)

Correspondence Address: PRYOR CASHMAN, LLP, 410 PARK AVENUE, NEW YORK, NY, 10022, US

(73) Assignee: KOREA ADVANCED INSTITUTE OF SCIENCE & TECHNOLOGY, Daejeon (KR)

(21) Appl. No.: 12/059,092

(22) Filed: Mar. 31, 2008

(30) Foreign Application Priority Data
Dec. 28, 2007 (KR) 10-2007-0139733

(51) Int. Cl. G06F 17/10

(52) U.S. Cl. 708/209

(57) ABSTRACT

An arithmetic apparatus for a multi-function unit and a method integrates all operations which are necessary to the GPU (graphics processing unit) with one operational device to decrease the area and power of the hardware and to control all operations except a matrix-vector multiplication to achieve a single-cycle throughput and to control a matrix-vector multiplication to achieve a 2-cycle throughput. Thus, the whole power consumption and the size and the efficiency of 3 dimensional graphics systems for the embedded systems such as the cell phone or Personal Digital Assistant can be improved as the GPU can be small-sized and advanced.

### RELATED APPLICATIONS

This nonprovisional application claims priority under 35 U.S.C. §119(a) on Patent Application No. 10-2007-0139733 filed in Republic of Korea on Dec. 28, 2007, the entire contents of which are hereby incorporated by reference.

### BACKGROUND FIELD

This document relates to an arithmetic apparatus for multi-function unit and method, and particularly, to an arithmetic apparatus for multi-function unit and method that can be low-power, small-sized, high-speed for 3 dimensional graphics processors (GPU) which are used widely on the internal system and computer system.

Generally, conventional 3 dimensional graphics processors had the large area and huge power consumption because they were configured for the high-performance computer systems like PC.

Recently, the real-time 3 dimensional graphics field is developing according to an improvement of hardware and an increase of application at very rapid pace. It raises an efficiency, and the CPU can be absorbed in a different work other than the graphics, according as the function which was formally executed in the CPU is passed to the graphics hardware.

However, the demand regarding 3 dimensional graphics processors at a handheld system such as a cellular phone or a PDA is recently increasing, and the specifications are also increasing gradually. Based on these increase, the programmable graphics pipeline which was adopted at the graphics processor for PC-based systems is adopted.

However, the 3D graphics system has the large area and huge power consumption because of it's nature, thus it has a many restriction from the area and power consumption.

Consequently, the graphics processor which is proposed for the system based on PC as a target has a problem which is not suitable for being used in the handheld system.

### SUMMARY

In aspect of this document is to provide an arithmetic apparatus for a multi-function unit and method which controls a matrix operation into a 2-cycle throughput and a vector operation and a calculation of transcendental function into a single-cycle throughput, thus it may control a throughput of GPU to increase largely. It also integrates these with one operational device, thus it may be low power and small-sized.

In an aspect, an arithmetic apparatus for multi-function unit integrates matrix operations, vector operations and transcendental functions in one operational device and comprises a logarithmic converter (LOGC) which converts a first input value into a logarithmic domain; the first adder for adding the result value of the LOGC and a second input value; a programmable multiplier (PMUL) being programmed to execute the target operation using the result value of the first adder and the second input value; a shifter for shifting the result value of the PMUL; a second adder for adding the result value of the LOGC and the result value of the shifter; a anti-logarithmic converter (ALOGC) for converting the result value of the second adder into the linear domain; and a programmable adder (PADD) being programmed to execute the target operation using the result values of the ALOGC and a third input value.

The arithmetic apparatus may include more adders to execute the matrix operation.

The vector operations and the transcendental functions may be performed in a single-cycle throughput, and the matrix operation may be performed in a two-cycle throughput.

The LOGC may be operated by a piecewise linear approximation subdividing the approximation regions.

The subdividing approximation regions may be the input regions near to ‘1’.

The transcendental function may be expanded in a Taylor series when it is converted into the logarithmic domain.

The first term of the Taylor series expansion may be added up directly in the PADD without passing the LOGC and the multiplier.

The PMUL, after re-compositing one 32b×24b multiplier, may be usable all of four ALOGCs being necessary to a matrix-vector multiplication, a vector multiplication, a division, a square root calculation and a vector linear interpolation, four LOGCs being necessary to a dot product calculation of vector, two LOGCs and two ALOGCs being necessary to a cross product operation, 32b×24b multiplier being necessary to a calculation of a power function, and four 32b×6b multipliers being necessary to a Taylor series expansion of a transcendental function.

The PMUL may be configured to have the LUT for a LOGC and share the adding up tree being necessary commonly in the LOGC and the multiplier, and may be configured to have the LUT for ALOGC and share the adding tree.

The PADD, after re-compositing one 4-way Single Instruction Multiple Data (SIMD) adder, may be programmed to 4-way SIMD adder for executing vector multiply-add, cross product, matrix-vector multiply, and be programmed to a S-input adding up tree for calculating a dot product and a trigonometric function.

The vector linear interpolation may execute the operation by using the first adder and the PMUL programmed to LOGCs.

The log function with two variables, by a following formula,

logₓ y=log₂ y/log₂ x=2^{log}^{₂}^{(log}^{₂} ^{y)-log}^{₂}^{(log}^{₂} ^{x)}

may be executed by coupling the LOGC in stage1 and the PMUL in stage2 programmed to a LOGC in series.

In another aspect, according to an arithmetic method for a multi-function unit using the arithmetic apparatus for the multi-function unit, the vector operation and the transcendental function may be programmed such that they are executed in a single-cycle throughput, and a matrix operation is programmed such that it is executed in a two-cycle throughput.

The PMUL may be programmed into four ALOGCs and the PADD may be programmed into a SIMD adder for the matrix operation.

The two-cycle throughput scheme divides a 4-element vector into two phases in a matrix-vector multiplication and comprises the first process converting into a log domain to execute an operation in the first phase and restoring it into the linear fixed/floating-point domain to add; and the second process converting into a log domain to execute an operation in the second phase and restoring it into the linear fixed/floating-point domain to add.

The conversion into the log domain may be embodied by a piecewise linear approximation subdividing input approximation regions.

The PMUL is programmed to two LOGCs and ALOGCs each in a cross product operation, and the PADD is programmed to a SIMD adder.

The subdividing approximation regions may be the input regions near to ‘1’.

The transcendental function, when being converted into the log domain, may be expanded in Taylor series and be converted.

The first term of the Taylor series expansion may be added directly in the PADD without passing the LOGC and the multiplier.

### BRIEF DESCRIPTION OF THE DRAWINGS

The invention will be described in detail with reference to the following drawings in which like numerals refer to like elements.

FIG. 1 illustrates an arithmetic apparatus for a multi-function unit according to a first embodiment of the present invention;

FIGS. 2a and 2b illustrate a logarithmic conversion method of an arithmetic apparatus for a multi-function unit according to a first embodiment of the present invention;

FIGS. 3a and 3b illustrate an anti-logarithmic conversion method of an arithmetic apparatus for a multi-function unit according to a first embodiment of the present invention;

FIG. 4 illustrates a PMUL (programmable multiplier) of an arithmetic apparatus for a multi-function unit according to a first embodiment of the present invention;

FIG. 5 illustrates a PADD (programmable adder) of an arithmetic apparatus for a multi-function unit according to a first embodiment of the present invention;

### DETAILED DESCRIPTION

Preferred embodiments of the present invention will be described in a more detailed manner with reference to the drawings.

The advantages and objects of the present invention and a method achieving the objects will be clearly understood by referring to the following embodiments which are described with reference to the accompanying drawings. However, it will be apparent to those skilled in the art that various changes and modifications may be made without departing from the scope of the invention as defined in the following claims. The present invention is only defined by the scope of claims in the present specification. Herein, the same reference number is given to the same constituent element throughout the specification although it appears in different drawings.

Hereinafter, preferred embodiments of the present invention will be described in detail with reference to the accompanying drawings.

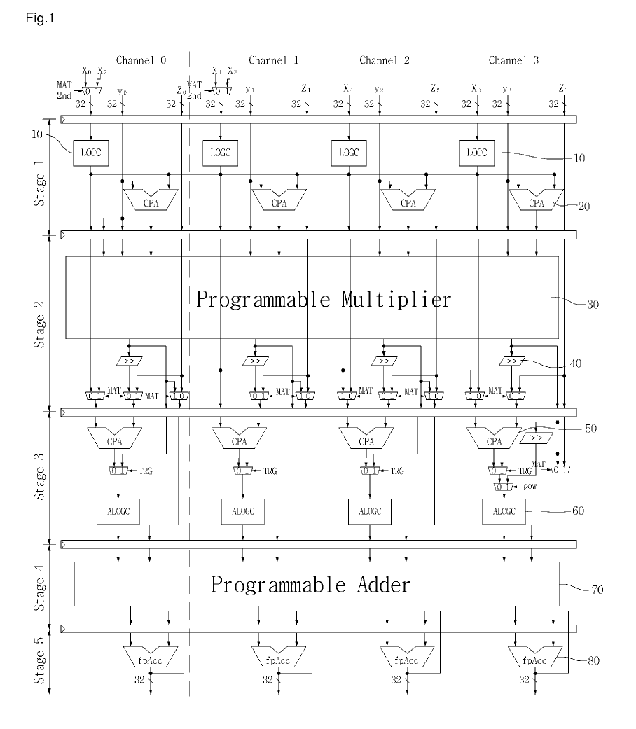

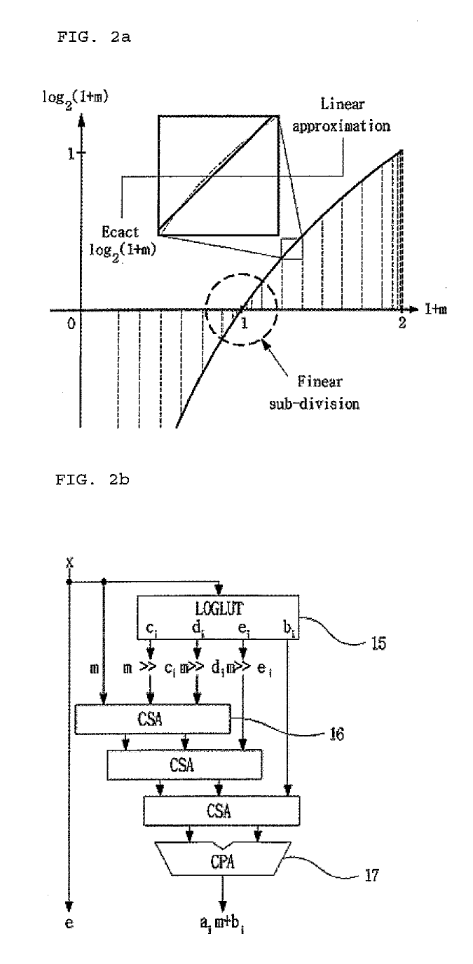

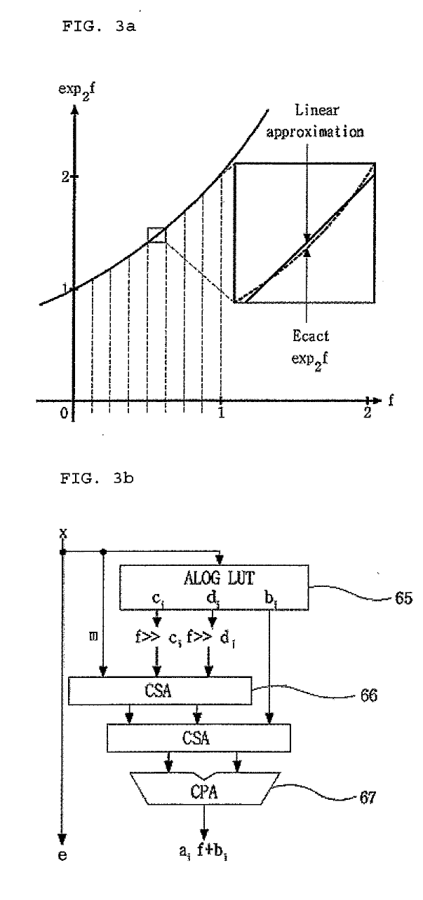

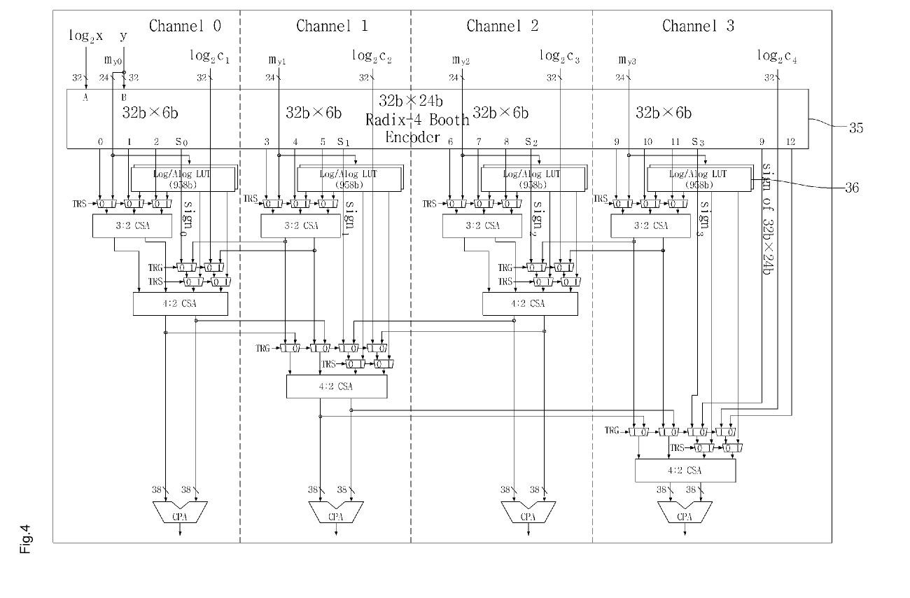

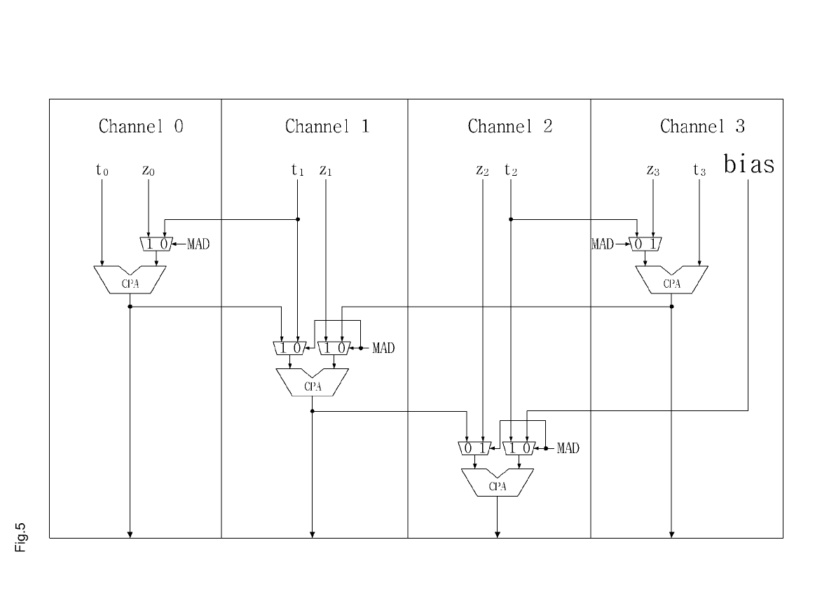

FIG. 1 illustrates an arithmetic apparatus for a multi-function unit according to a first embodiment of the present invention, and FIGS. 2a and 2b illustrates a logarithmic conversion method of an arithmetic apparatus for a multi-function unit according to the first embodiment of the present invention, and FIGS. 3a and 3b illustrates a anti-logarithmic conversion method of an arithmetic apparatus for a multi-function unit according to the first embodiment of the present invention, and FIG. 4 illustrates a PMUL (programmable multiplier) of an arithmetic apparatus for a multi-function unit according to the first embodiment of the present invention, and FIG. 5 illustrates a PADD (programmable adder) of an arithmetic apparatus for a multi-function unit according to the first embodiment of the present invention.

FIG. 1 illustrates an arithmetic apparatus for a multi-function unit according to the first embodiment of the present invention.

As illustrated in FIG. 1, an arithmetic apparatus for a multi-function unit according to the first embodiment of the present invention is composed of a pipeline of 4-channel and 5-stage, and a stage1 comprises a LOGC (logarithmic converter) 10 converting a first input data x into a log domain, and a stage2 comprises a PMUL (programmable multiplier) 30 according to a target operation for calculating using the result value of the first adder and a second input value y. The stage3 comprises a ALOGC (anti-logarithmic converter) 50 to convert an operation result of the log domain into a result of a fixed-point/floating-point linear domain, and a stage4 comprises a PADD (programmable adder) 70 according to the target operation for calculating using the result value of the ALOGC 50 and a third input value z. A stage5 comprises an accumulator 80 to execute a matrix operation to be explained below.

Herein, the stage1 further comprises a first adder 20 for adding up the result value of the LOGC 10 and the second input value y, and the stage2 further comprises a shifter 40 for shifting the result value of the PMUL 30, and the stage3 further comprises a second adder 50 for adding up the result value of the LOGC 10 and that of the shifter 40.

Particularly, the present invention manages a data of fixed-point number system or floating-point number system as an input-output data, and converts an input data of fixed-point or floating-point in order to reduce a complexity of an operation into a Logarithmic Number System (LNS) (i.e., a data of log domain) to calculate. Hereby, the data calculated with a log number is converted into the data of the fixed-point or floating-point which is an input-output type and is outputted.

In this case, as an accuracy of the logarithmic converter which converts the data of the fixed-point/floating-point into the data of LNS decides on the accuracy of the operation, it is important to reduce a conversion error of the LOGC.

Also, the present invention uses a piecewise linear approximation in order to operate the LOGC with a low power. The LOGC divides the fractional part of [0,1] of input data into several approximation regions to approximate each individual approximation region linearly, an integer portion can be obtained by counting a position of leading one from a fraction point in case of a data of a fixed-point and by taking an exponent part incase of a data of floated-point. In this time, the nearer approaches an input data to ‘1’ in a logarithmic function, the nearer approaches an output data to ‘0’, therefore a ratio (%) in an unit value of a small error value has a problem which appears highly in this piece.

In order to solve this, the present invention proposes a technique reducing an error by approximating more piecewise the approximating piece in the segment near to ‘1’.

FIGS. 2a and 2b illustrate the device that embodies a log conversion based on the piecewise linear approximation according to the present invention and the piecewise linear approximation using thereof with an adding up tree being composed of LUT (lookup table, 15), CSA (Carry Save Adder, 16), and CPA (Carry Propagation Adder, 17), and it uses a method reducing an error by approximating more piecewise the approximating piece in the segment near to ‘1’.

FIGS. 3a and 3b illustrate an anti-logarithmic conversion according to the present invention and a device using thereof, as illustrated in FIGS. 2a and 2b, as an anti-logarithmic conversion converting a result value operated in a log domain into a result of a fixed/floating-point (i.e., linear domain), and it uses a method to reduce an error with simple low power hardware by using the device operated by an adding up tree being composed of LUT (65) CSA 66 and CPA 67 for a piecewise linear approximation.

FIG. 4 illustrates a PMUL (programmable multiplier) composition of an arithmetic apparatus for a multi-function unit according to the first embodiment of the present invention

In other word, vector operations are in want of 8 LOGCs, and a Booth multiplier in a log domain is not in want of them, but the transcendental function is in want of 1 LOGC and Booth multiplier in the log domain.

The conventional invention had 8 LOGCs in stage1 and a Booth multiplier in stage2 (i.e., log domain) to implement a vector operation and a transcendental function operation together. However, it brought about the result which the Booth multiplier is wasted on the vector operation and 7 logarithmic converters are wasted on the transcendental function.

Consequently, as illustrated in FIG. 4, the present invention uses an adaptive number conversion to put 4 logarithmic converters of 8 logarithmic converters in stage1 and the residual 4 logarithmic converters in stage2. Also, it owns jointly the adding up tree being commonly necessary to the LOGC and the Booth multiplier to make the PMUL of FIG. 4 to be programmable, and controls on a vector operation to be programmed to a LOGC and on a transcendental function to be programmed to a Booth multiplier, thus it may reduce the waste which is unnecessary.

Also, it adds a LUT (36) for an anti-logarithmic conversion in the PMUL and owns jointly an adder tree to control for being programmed to a ALOGC, thus it may be used in a matrix—vector multiplication, a cross-product etc.

The PMUL, after re-compositing one 32b×24b multiplier, is usable all of four ALOGCs being necessary to a matrix-vector multiplication, a vector multiplication, a division, a square root calculation and a vector linear interpolation, four LOGCs being necessary to a dot product calculation of vector, two LOGCs and ALOGOCs being necessary to a cross product operation of vector, 32b×24b multiplier being necessary to a calculation of a power function, and four 32b×6b multipliers being necessary to a Taylor series expansion of a transcendental function.

FIG. 5 illustrates a PADD (programmable adder) of an arithmetic apparatus for a multi-function unit according to a first embodiment of the present invention.

It can be programmed to a 4-way SIMD adder for the execution of a vector multiply-add, a cross product, and a matrix-vector multiplication, and can be programmed to a 5-input adding up tree for the execution of a dot product and a trigonometric function.

The arithmetic apparatus for a multi-function unit according to the present invention configured as above, in order to reduce the complexity of operations which are used in the GPU, converts all operations except an addition and a subtraction into a log domain to execute, thus it has a merit reducing the complexity of an operation by converting a multiplication into an addition, a division into a subtraction, a square root into a right shift, and a power law function into a multiplication to execute in a log domain.

For this, it is in want of a LOGC converting an input value into the log domain and an ALOGC converting a calculated value in the log domain into a linear domain. In particular, in order to reduce the complexity of transcendental functions (a trigonometric function, a hyperbolic function, inverse of them), the present invention is expanded in Taylor series to calculate in the log domain. Thus it can control to reduce the complexity of the operation on transcendental functions.

In other words, the conventional inventions has an instance increasing a performance by using in the log domain, however none has an instance integrating the power law function and transcendental function with one operational device to be embodied by a single-cycle throughput.

The present invention executes a matrix operation which is necessary to the GPU with 2-cycle throughput and a vector/transcendental function with a single-cycle throughput, thus it increases a throughput of the GPU largely, and it integrates these with one operational device and controls for being low power and small-sized.

Here in after, an executing method on each operation proposed in the present invention will be described as following below.

1. Matrix-Vector Multiplication

In order to implement a geometry transformation required in 3-dimensional graphics, it is in want of a multiplication of a 4×4 matrix and a 4-element vector. As illustrated in a numerical formula (1), it is in want of 16 multiplication operations, and is in want of 20 LOGCs, 16 adders, 16 ALOGCs in a log domain.

As the coefficients of a geometry transformation matrix in 3 dimensional graphics are fixed while transforming a 3 dimensional object, matrix coefficients can be converted into a log domain in advance before the operation is executed.

Consequently, the number of 20 LOGCs which is necessary to execute an operation of the numerical formula (1) decreases to 4 LOGCs only for a vector element conversion, thus it is in want of 4 LOGCs, 16 adders and 16 ALOGCs for the numerical formula (1).

In order to implement this in the 4-way arithmetic unit proposed in the present invention, as illustrated in the numerical formula (1), if it is divided into 2 phases and implemented, then 1 phase is in want of only 2 LOGCs, 8 adders and 8 ALOGCs. 8 adders which are necessary in this time may use the first and second adders in stage 1 and stage 3, and 8 ALOGCs may use 4 ALOGCs of stage 3 and program the PMUL of stage 2 to 4 ALOGCs to be operated.

The operation result of the phase1 can be obtained by programming the PADD into a 4-way SIMD adder to add the results of the anti-logarithmic conversion in stage2 and those of the anti-logarithmic in stage3, and repeated process obtains the result of the phase2 and accumulation of the result of phase 1 and 2 through the accumulator of the stage 5 obtains the last operation result. With this method, it can improve the matrix-vector multiplication embodied by a 4-cycle throughput in a conventional 4-way arithmetic unit to the 2-cycle throughput.

2. Add, Subtract

An addition and a subtraction are not converted into a log domain and are managed in a fixed/floated point domain. It uses a first adder 20 of the stage 1 which is described in FIG. 1.

3. Vector Multiply, Divide, Square-Root and Multiply-Add, Divide-Add, Square-Root-Add

As illustrated in a numerical formula (2), a multiplication, a division and a square root are processed in a log domain after being converted into an addition, a subtraction, and a right shift operation, respectively. The PMUL (30) of the stage 2 illustrated in FIG. 1 for this is programmed to 4 LOGCs, and uses the shifter 40 of the stage 2 and the second adder 50 of the stage 3.

(xᵢ [symbol] yᵢ^{p}⊕zᵢ)_{iε{0,1,2,3}}=(2^{(log}^{₂} ^{x}^{ᵢ}^{)⊕(log}^{₂} ^{y}^{ᵢ}^{^{q}}⁾⊕zᵢ)_{iε{0,1,2,3}} (2)

wherein, [symbol] ε{×,÷}, ⊕ε{+,−}, p ε{0.5,1}, q ε{0,1}.

4. Vector Linear Interpolation

As illustrated in a numerical formula (3), log₂(zᵢ−yᵢ) is in want of a log conversion after executing a subtraction. For this, the PMUL 30 of the stage2 is programmed to a LOGC, and embodies a log conversion after using the first adder 20 of the stage1 to execute a subtraction.

(xᵢ(zᵢ−yᵢ)+yᵢ)_{iε{0,1,2,3}}=(2^{log}^{₂} ^{x}^{ᵢ}^{+log}^{₂}^{(x}^{ᵢ}^{-y}^{ᵢ}⁾+yᵢ)_{iε{0,1,2,3}} (3)

5. Dot-Product and Cross-Product

The vector dot-product is defined as the total of the terms being composed of a multiplication of each element of two vectors. Accordingly, after the multiplication between two vector elements being executed in a log domain, it executes an anti-logarithmic conversion into a fixed/floated point domain and adds results of it's multiplications to obtain. For this, The PMUL 30 in stage2 is programmed to 4 LOGCs.

As illustrated in a numerical formula (4), it is in want of 12 LOGCs, 6 adders, 6 ALOGCs because a cross-product is in want of 6 multipliers, however it can decrease the number of the required LOGCs into 6 for using only 6 operands different with each other.

$$[ \begin{matrix}{x}_{1} {y}_{2} - {y}_{1} {x}_{2} \\ {x}_{2} {y}_{0} - {y}_{2} {x}_{0} \\ {x}_{0} {y}_{1} - {y}_{0} {x}_{1}\end{matrix} ] = [ \begin{matrix}{2}^{{log}_{2} {x}_{1} + {log}_{2} {y}_{2}} - {2}^{{log}_{2} {y}_{1} + {log}_{2} {x}_{2}} \\ {2}^{{log}_{2} {x}_{2} + {log}_{2} {y}_{0}} - {2}^{{log}_{2} {y}_{2} + {log}_{2} {x}_{0}} \\ {2}^{{log}_{2} {x}_{0} + {log}_{2} {y}_{1}} - {2}^{{log}_{2} {y}_{0} + {log}_{2} {x}_{1}}\end{matrix} ] \qquad ( 4 )$$

Consequently, by programming the PMUL (30) in stage 2 into 2 LOGCs and 2 ALOGCs, 6 LOGCs and 6 ALOGCs being necessary to a dot product can be obtained from converters of stage 1, 2, 3, and 6 adders can be obtained from the second adder in stage 3 (60) and the first adders (20) in stage 1.

6. Logarithmic Function (logₓ y)

The base of logarithmic function was a constant in a conventional invention, however the present invention executes the logarithmic function having 2 variables. The logarithmic function which has 2 variables can be executed by using a log domain operation such as a numerical formula (s).

logₓ y=log₂ y/log₂ x=2^{log}^{₂}^{(log}^{₂} ^{y)-log}^{₂}^{(log}^{₂} ^{x)} (5)

The numerical formula (5) is in want of 2 LOGCs, and it programs the PMUL 30 of the stage 2 to 2 LOGCs and connects the LOGC of the stage 1 and the stage 2 in series to be executed.

7. Power Function

A power function is one of the functions which a complexity of an operation is large, but it is possible to calculate with a multiplication, as illustrated in a numerical formula (6), in a log domain.

x^{y}=2^{y×log}^{₂} ^{x} (6)

Consequently, as illustrated in FIG. 4, the present invention makes a PMUL to be programmable with one full-word multiplier 35, thus it makes the calculation of the power function to be possible.

8. Trigonometric Function (a Trigonometric Function, a Hyperbolic Function, an Inverse-Trigonometric Function, an Inverse-Hyperbolic Function)

The trigonometric function (a trigonometric function, a hyperbolic function, an inverse-trigonometric function, an inverse-hyperbolic function) through a Taylor series expansion controls to be converted into a log domain to reduce the complexity of the operation. In order to calculate each terms used in the Taylor series expansion on a trigonometric function, it is required to calculate the power function and the coefficient multiplication with the input value on each term, and these operations are converted into a multiplication and an addition when these are converted into the log domain, as illustrated in a numerical formula (7).

c₀x^{k}^{₀}⊕c₁x^{k}^{₁}⊕c₂x^{k}^{₂}⊕c₃x^{k}^{₃}⊕c₄x^{k}^{₄}⊕=c₀x^{k}^{₀}⊕2^{(log}^{₂} ^{c}^{₁}^{+k}^{₁}^{×log}^{₂} ^{x)}⊕2^{(log}^{₂} ^{c}^{₂}^{+k}^{₂}^{×log}^{₂} ^{x)}⊕2^{(log}^{₂} ^{c}^{₃}^{+k}^{₃}^{×log}^{₂} ^{x)}⊕2^{(log}^{₂} ^{c}^{₄}^{+k}^{₄}^{×log}^{₂} ^{x)} (7)

wherein ⊕ᵢε{+,−}, and cᵢ and kᵢ is a positive real number and an integer, respectively.

Herein, the multiplication is executed by programming a PMUL into a 4-way multiplier. This multiplier is illustrated in FIG. 4 and can be composed of one full-word multiplier as the whole, and it also can be composed of a 4-way sub-word multiply-and-add unit.

The terms obtained by this method, as illustrated in FIG. 5, can be added up by programming a PADD into a 5-input adding up tree and a trigonometric function can be executed.

The first term becomes always a constant ‘1’ or the same as the first term for the Taylor series expansion in above numerical formula, thus it can be added directly in an adding up tree without passing a LOGC and a multiplier to reduce one LOGC and multiplier, as illustrated in FIG. 5. Hereby, it can approximate each trigonometric function to the Taylor series of 5 terms and reduce the error from the approximation.

According to the present invention described above, an arithmetic apparatus for a multi-function unit and a method integrates all operations which are necessary to the GPU (graphics processing unit) with one operational device. Thus, it decreases the area of the hardware. Also, it controls all operations except a matrix-vector multiplication to achieve a single-cycle throughput and controls a matrix-vector multiplication to achieve a 2-cycle throughput. Thus, the whole power consumption and the size and the efficiency of 3 dimensional graphics systems for the embedded system such as the personal digital assistant can be improved as the CPU can be small-sized and advanced.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

What is claimed is:

1. An arithmetic apparatus for multi-function unit in which matrix operation, vector operations, and transcendental functions are integrated into single operational device comprising:
a LOGC which converts the first input value into a logarithmic domain;
a first adder for adding the result value of the LOGC and the second input value;
a PMUL being programmed to execute the target operation using the result value of the first adder and the second input value;
a shifter for shifting the result value of the PMUL;
a second adder for adding the result value of the LOGC and the result value of the shifter;
a ALOGC for converting the result value of the second adder into the linear fixed/floating-point domain; and
a PADD being programmed to execute the target operation using the result values of the ALOGC and a third input value.

2. The arithmetic apparatus of claim 1, further comprising an adder to execute the matrix operation.

3. The arithmetic apparatus of claim 1, wherein the vector operations and the transcendental functions are performed in a single-cycle throughput, and the matrix operation is performed in a two-cycle throughput.

4. The arithmetic apparatus of claim 1, wherein the LOGC is operated by a piecewise linear approximation subdividing each approximation region.

5. The arithmetic apparatus of claim 4, wherein the subdividing approximation region is the input value near to ‘1’.

6. The arithmetic apparatus of claim 1, wherein the trigonometric function is expanded into the Taylor series when it is converted into the log domain.

7. The arithmetic apparatus of claim 6, wherein the first term of the Taylor series expansion is added directly from PADD without passing the LOGC and the multiplier.

8. The arithmetic apparatus of claim 1, wherein the PMUL, after re-compositing one 32b×24b multiplier, is usable all of four ALOGCs being necessary for a matrix-vector multiplication, a vector multiplication, a division, a square root calculation and a vector linear interpolation, four LOGCs being necessary for a dot product, two LOGCs and ALOGCs being necessary for a cross product, a 32b×24b multiplier being necessary for a power function, and four 32b×6b multipliers being necessary for a Taylor series expansion of a trigonometric function.

9. The arithmetic apparatus of claim 8, wherein the PMUL is configured to have the LUT for a LOGC and share the adding up tree being necessary commonly in the LOGC and the multiplier, and is configured to have the LUT for ALOGC and share the adding tree.

10. The arithmetic apparatus of claim 1, wherein the PADD, after re-compositing one 4-way SIMD adder, is programmed to a 4-way SIMD adder for executing a vector multiply-add, a cross product, a matrix-vector multiply, and is programmed to a 5-input adding up tree for calculating a dot product and a trigonometric function.

11. The arithmetic apparatus of claim 8, wherein the vector linear interpolation executes the operation by using the first adder and then is embodied by the PMUL.

12. The arithmetic apparatus of claim 8, wherein the log function having two variables, by a following formula,
logₓ y=log₂ y/log₂ x=2^{log}^{₂}^{(log}^{₂} ^{y)-log}^{₂}^{(log}^{₂} ^{x)}
is executed by coupling the LOGC in stage1 and the PMUL in stage2 programmed to a LOGC in series.

13. The arithmetic apparatus for the multi-function unit of claim 1, wherein, the vector operation and the transcendental function are executed by a single-cycle throughput and the matrix operation is executed by a two-cycle throughput.

14. The arithmetic method of claim 13, wherein, the PMUL is programmed to four ALOGCs and the PADD is programmed to a SIMD adder, for a matrix-vector multiplication.

15. The arithmetic method of claim 13, wherein the two-cycle throughput scheme divides a 4-element vector into two phases in a matrix-vector multiplication and comprises the first process converting into a log domain to execute an operation in the first phase and restoring it into the linear fixed/floating-point domain to add; and the second process converting into a log domain to execute an operation in the second phase and restoring it into the linear fixed/floating-point domain to add.

16. The arithmetic method of claim 13, wherein the conversion into the log domain is embodied by a piecewise linear approximation subdividing each approximation region to approximate.

17. The arithmetic method of claim 13, wherein the PMUL is programmed to two LOGCs and ALOGCs each in a cross product operation, and the PADD is programmed to a SIMD adder.

18. The arithmetic method of claim 16, wherein the subdividing the approximation region to approximate is the input value near to ‘1’.

19. The arithmetic method of claim 13, wherein the transcendental function is expanded in Taylor series when it is converted into the log domain.

20. The arithmetic method of claim 13, wherein the first term of the Taylor series expansion is added directly from PADD without passing the LOGC and the multiplier.
